(19) United States
(12) Patent Application Publication
(10) Pub. No.: US 2026/0133382 A1
(43) Pub. Date: May 14, 2026

(54) ADAPTER FOR COUPLING LIGHT FROM A PHOTONIC CIRCUIT

(71) Applicant: Commissariat à l'Énergie Atomique et aux Énergies Alternatives, Paris (FR)

(72) Inventor: Olivier Castany, Grenoble (FR)

(73) Assignee: Commissariat à l'Énergie Atomique et aux Énergies Alternatives, Paris (FR)

(21) Appl. No.: 19/382,417

(22) Filed: Nov. 7, 2025

(30) Foreign Application Priority Data
Nov. 12, 2024 (FR) FR2412332

(51) Int. Cl. G02B 6/42

(52) U.S. Cl. CPC G02B 6/4214

(57) ABSTRACT

An optical adapter intended to be used as an interface on an optical integrated circuit to produce a widened light beam and thus facilitate the coupling with optical fibers and/or an optical connector. The optical adapter includes a planar mirror on its upper surface and a converging mirror on its lower surface. The light beam propagates by widening between the optical integrated circuit and the converging mirror inside the transparent optical adapter, the path being folded back due to the upper planar mirror.

### CROSS-REFERENCE TO RELATED APPLICATIONS

This application claims priority to French application number FR2412332, filed Nov. 12, 2024. The contents of this application is incorporated herein by reference in its entirety.

### TECHNICAL FIELD

The present description generally concerns the field of optical integrated circuits, also known as photonic integrated circuits (PICs), and more particularly the coupling of light, or optical coupling, between an optical integrated circuit and one or more optical fibers.

### PRIOR ART

Optical integrated circuits, in particular photonic circuits on silicon, can combine many functions on a single chip. This is an advantage, in particular in terms of bulk decrease and of optical losses, as compared with assemblies formed by assembling discrete components. In photonic integrated circuits, light is guided in optical waveguides of small size, having a width typically smaller than one micrometer, which enables to form dense circuits. Optical integrated circuits communicate by exchanging light with external systems, the coupling of this light being performed while attempting to limit optical losses. The issue of optical coupling is particularly critical in the case of single-mode optical beams, intended for example to be coupled in single-mode optical fibers, due to the small diameter of the light beams involved.

In an optical integrated circuit, optical waveguide coupling interfaces are generally of two types:
1) vertical grating couplers, operating due to the diffraction of light on a periodic structure formed at the end of the optical waveguide to send the light to the top of the chip, and more precisely at an angle close to the vertical of the chip, for example an 8° angle (angle considered in a medium having a refractive index equal to that of silica glass), the grating couplers enabling to form a light beam having a diameter in the order of some ten micrometers, which is adapted to the single-mode optical fibers commonly used for optical communications; and
2) edge couplers typically located at the edge of the circuit and formed by an optical guide which stops at the edge of the chip, the light then exiting in line with the guide. The end portion of the guide may also have a structure which widens the optical mode before its coming out the chip. The beam size is typically in the range from two to ten micrometers. A variant of edge coupling may comprise a cavity, for example a well, formed in the upper surface of the circuit, providing access to an output of the optical guide. A mirror located in the cavity opposite the end of the optical guide enables in this case to sample light by reflecting it in a direction outside the plane of the chip, typically a direction close to vertical.

The two above-mentioned types of interfaces enable to form single-mode light beams having a maximum diameter close to some ten micrometers. In this case, a direct coupling with optical fibers is possible, but the beam diameter remains small, in the sense that it requires positioning the optical fibers with a positioning accuracy smaller than plus or minus 2 μm to obtain an acceptable coupling rate. This positioning accuracy is difficult to achieve and requires using dedicated, expensive, and slow machines. To facilitate the coupling and increase positioning tolerance, it is desirable to widen the diameter of the light beam coming out of the optical integrated circuit to several tens of micrometers, for example approximately 50 μm, which enables to release the positioning tolerance to plus or minus 10 μm and accordingly makes the assembly less touchy, thus enabling to use less expensive and faster machines.

Several techniques have been provided to couple light between an optical integrated circuit and optical fibers with a widened beam diameter. In all cases, an optical path sufficiently long for the light beam to widen to the desired size is considered. The different techniques differ by the optical scheme used and by the portion of the optical path along which the beam widens.

Further, the case of edge coupling requires attaching the optical fiber to the edge of the chip, which is mechanically fragile. To avoid this disadvantage and attach the fiber to the upper surface of the chip while remaining in an optical configuration similar to edge coupling, a cavity can be formed from the upper surface of the chip, said cavity having a vertical wall in front of the end of the optical guide, so that the beam which comes out of the optical guide passes through this wall and penetrates the cavity. Inside the cavity, a turning mirror is arranged to intercept the beam and deflect it upward so that it exits through the upper surface of the chip in a direction close to vertical. The manufacturing of this turning mirror can be performed by using various techniques and is an industrial issue.

U.S. Pat. Nos. 9,817,193, 10,209,442, 10,459,163, and 10,690,848, and French patent FR 3066615 describe optical integrated circuits in which beam expansion is achieved across the thickness of the chip substrate and in which the back side of the chip comprises an optical function, lens or mirror. This solution enables to integrate the beam expansion function inside the chip with no additional element. However, a disadvantage is that, to pass through the thickness of the chip between the guiding area and the back side of the substrate, light must pass through the interface between the silica and the silicon, and the high refractive index contrast between these materials means that a non-negligible part of the light, approximately 15%, is reflected at the interface and lost. For technological reasons, it is difficult and costly to place an anti-reflective layer at this location. Another disadvantage is that the desired optical function (lens or mirror, according to the case) is carried out on the back side of the chips. Now, the carrying out of processes on the back side involves higher manufacturing costs because the front side needs to be protected, and then unprotected. Another disadvantage is that the thickness of the substrate cannot be selected independently of the desired mode diameter, because the length of the path in the substrate determines the size of the transmitted mode, the widening being determined by the natural diffraction of the beam.

French patent application FR 3050832, previously filed by the applicant, describes an optical element which enables to sample the beam from a cavity, in a case of edge coupling, by means of a reflector playing the role of a turning mirror. However, the optical element described in the above-mentioned application does not have the function of widening the light beam.

French patent FR 3124001, previously obtained by the applicant, discloses an optical integrated circuit topped by a transparent chip in which the beam propagates while widening. The transparent chip comprises a planar mirror on its upper surface, which enables to fold the beam toward a collimating mirror manufactured on the optical integrated circuit, to produce a widened light beam. The advantage of this solution is that the positioning tolerance of the transparent chip is relaxed as compared with the plus or minus 2 μm required for a direct coupling to the optical fibers. In the case of edge coupling, patent FR 3124001 describes the possibility of manufacturing a turning mirror in the optical circuit opposite the guide output. However, the manufacturing of a turning mirror in the optical circuit, for example at the bottom of a cavity, can turn out being tricky, and manufacturers of optical integrated circuits may decide not to include such a mirror in their manufacturing process.

US patent application US 2023/025139 filed by Teramount describes an optical scheme comprising a first optical element focusing light onto an optical fiber, and a second optical element focusing light into the optical port of an optical integrated circuit. This system enables to perform a connection between the fiber and the optical circuit while benefiting of a relaxed positioning tolerance. Indeed, as described in relation with FIGS. 4A and 4B of the above-mentioned application, a displacement of the upper block is compensated for by a variation in the angle of the rays between the first and second optical elements. For example, a rightward shift of the upper block is compensated for by an inclination of the rays that approaches the horizontal. This optical scheme requires two focusing optical elements. Further, it is not intended to produce a widened and collimated light beam coming out of the device upward.

### SUMMARY OF THE INVENTION

There exists a need to overcome all or part of the disadvantages of existing devices of optical coupling between an optical circuit and one or more optical fibers.

For this purpose, an embodiment provides an optical adapter comprising:
a transparent region;
a converging mirror located on the side of a first surface of the transparent region and facing a second surface of the transparent region, opposite to the first surface;
a first planar mirror located on the side of the second surface of the transparent region and facing the first surface;
a first optical port located on the side of the first surface and intended to be positioned opposite one end of a waveguide of an optical integrated circuit; and
a second optical port located on the side of the second surface,
   the optical adapter being designed to ensure the propagation of a light beam between said end of the waveguide and the second optical port, the first planar mirror and the converging mirror being arranged so that the light beam propagates between the first and second optical ports, through the transparent region, by reflection on the first planar mirror and on the converging mirror, the light beam having, at the second optical port, a size greater than the one that it has at the first optical port.

According to an embodiment, the adapter further comprises a second planar mirror located on a portion of the transparent region projecting from its first surface, said portion being intended to be inserted into a cavity of the optical integrated circuit.

According to an embodiment, the adapter comprises no optical elements other than the transparent region, the first planar mirror, and the converging mirror.

According to an embodiment, the transparent region further comprises at least one element for mechanically positioning the adapter with respect to the optical integrated circuit.

According to an embodiment, said at least one mechanical positioning element projects from the first surface of the transparent region.

According to an embodiment, said at least one mechanical positioning element comprises at least one pad having no optical function, intended to bear on the optical integrated circuit.

According to an embodiment, said at least one mechanical positioning element further comprises at least one finger having no optical function and intended to be inserted into a cavity in the optical integrated circuit.

According to an embodiment, the first and second optical ports are respectively adapted to receiving and emitting the light beam.

According to an embodiment, the first surface of the transparent region is parallel to its second surface, the first planar mirror being parallel to the second surface.

According to an embodiment, the second optical port is intended to be positioned opposite an optical connector having one end of an optical fiber ending into it.

An embodiment provides an optical device comprising an optical integrated circuit and the optical adapter such as described, the optical adapter being mechanically integral with the optical integrated circuit.

According to an embodiment, the optical adapter is attached to the optical integrated circuit by a layer of optically transparent glue.

According to an embodiment, the device further comprises at least one optical connector positioned opposite the second optical port and having the end of an optical fiber ending into it.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a side and cross-section view, simplified and partial, of an optical adapter assembled to an optical integrated circuit according to an embodiment, with the indication of geometric notations used in the disclosure;

FIG. 2 is a detail view of the assembly of FIG. 1, at the level of an area of beam sampling in a cavity;

FIG. 3 is a side and cross-section view, simplified and partial, of a variant of the optical adapter of FIG. 1, comprising bearings;

FIG. 4 is a side and cross-section view, simplified and partial, of another variant of the optical adapter of FIG. 1, comprising a curved mirror and a positioning element;

FIG. 5 is a side and cross-section view, simplified and partial, of an optical device according to an embodiment, showing in particular the use of an optical micro-connector; and

FIG. 6 is a side and cross-section view, simplified and partial, of a variant of the optical integrated circuit and of the optical adapter, in the case of a beam coupled to a vertical coupling grating.

### DESCRIPTION OF EMBODIMENTS

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and have been described in detail. In particular, the applications implementing optical integrated circuits and optical devices comprising such circuits have not been detailed, the described embodiments being compatible with all or most applications implementing optical integrated circuits and optical devices comprising such circuits, possibly subject to adaptations within the abilities of those skilled in the art on reading of the present disclosure.

Unless otherwise specified, when reference is made to two elements being connected to each other, this means directly connected without any intermediate elements other than conductors, and when reference is made to two elements being coupled to each other, this means that these two elements may be connected or may be connected via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

Unless otherwise specified, the expression “in contact with” signifies “in mechanical contact with.”

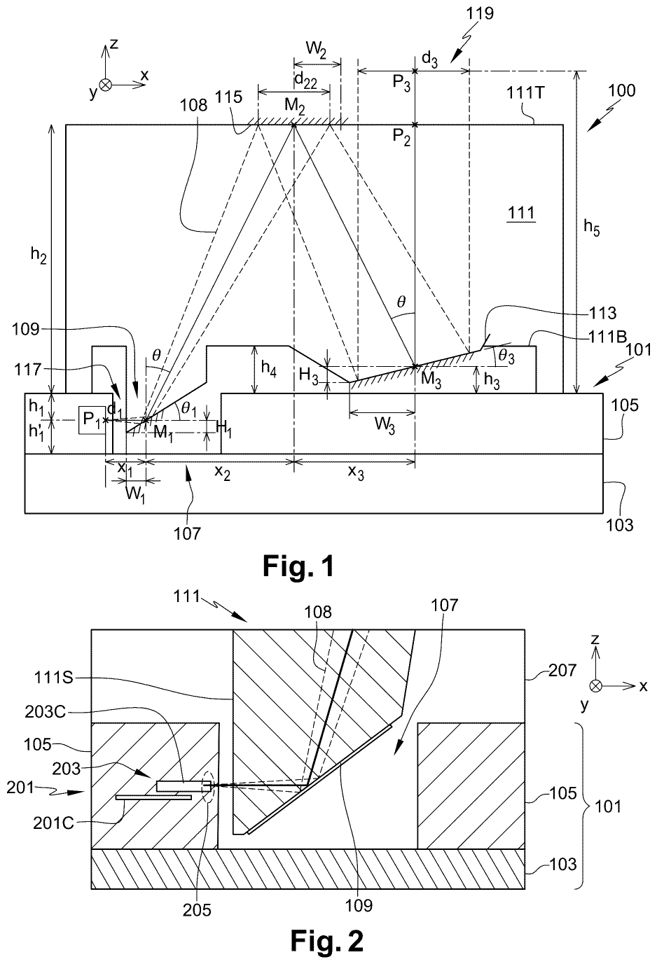

FIG. 1 is a side and cross-section view, simplified and partial, of an optical adapter 100 assembled with an optical integrated circuit 101, also called integrated photonic circuit 101 or photonic chip 101, according to an embodiment.

Optical integrated circuit 101 is, for example, a photonic circuit on silicon, that is, an optical circuit formed on a silicon substrate 103. As a variant, substrate 103 may be made of a material different from silicon, for example, of a III-V semiconductor material, of silicon carbide, etc.

Optical integrated circuit 101 may implement one or more elementary functions (not detailed in the drawings), selected for example from among:
an electro-optical light modulation function;
a function of photodetection, for example by means of a photodiode;
a wavelength filtering function;
an optical routing function; and
an electrical conduction function.

In the shown example, the elementary function(s) are implemented by one or more elementary components formed in a transparent region 105 located on the surface of optical integrated circuit 101. Transparent region 105 may be homogeneous, that is, made of a single transparent material, or inhomogeneous, that is, made of a plurality of different transparent materials, possibly comprising cavities or air pockets. The concept of transparency is considered at an operating wavelength λ₀ of optical integrated circuit 101. The material(s) of transparent region 105 are, for example, selected from among silica glass, silicon nitride, polymers transparent at operating wavelength λ₀, etc.

The elementary optical components are, for example, coupled together by one or more optical guides typically comprising a central region, or optical core, surrounded by a peripheral region, or optical sheath, the peripheral region having a refractive index lower than that of the central region. As an example, the central region is made of silicon or of silicon nitride and the peripheral region is made of silica glass. As a variant, other types of optical circuits 101 can be envisaged, for example circuits comprising optical guides made of a III-V semiconductor material.

An optical link between optical integrated circuit 101 and the outside of the circuit is achieved by means of at least one vertical optical coupler with a diffraction grating and/or of at least one optical edge coupler.

FIG. 1 more particularly illustrates the case of an edge coupling. As an example, the mode diameter can advantageously be widened by transferring the light into a silicon nitride guide of small thickness, for which mode diameter d₁ is, for example, equal to approximately 9.0 μm. In the case of a single-mode beam, there is meant by “mode diameter” a diameter for which the light intensity is decreased by a factor 1/e², where “e” represents the exponential, with respect to the center of the beam. The beam has, for example, a Gaussian shape.

Transparent region 105, for example, has a thickness selected so as to contain the entire optical mode of the coupler. As an example, the beam axis is located at a depth h₁ equal to approximately 7.0 μm below the upper surface of the optical integrated circuit. A cavity 107 is for example formed opposite the edge coupler to be able to access the beam and sample it. Cavity 107 has, for example, a depth h′₁ below the axis of the beam equal to approximately 7.0 μm. There is noted P₁ a point at the center of the beam at the end of the edge coupler, from which the light begins to diverge.

Optical adapter 100 is assembled on optical circuit 101 and enables to produces a widened and collimated light beam 108 directed upward, in the orientation of FIG. 1. In FIG. 1, beam 108 comprises an optical axis symbolized by a solid line and an envelope symbolized by two dotted lines located on either side of the optical axis of beam 108. In the shown example, the adapter comprises a pickoff mirror 109 intended to be inserted into cavity 107 to sample the beam coming out of the coupler through the edge and direct it in a direction close to vertical. Mirror 109 is, in this example, a planar mirror. In FIG. 1, there is noted M₁ the point of intersection of the surface of mirror 109 with the optical axis of the beam 108 originating from the coupler, and an orientation of mirror 109 such that the optical axis P₁M₁, initially horizontal, is, after reflection on mirror 109, oriented at an angle θ equal to approximately 16.0° relative to the vertical, is considered. To obtain angle θ, pickoff mirror 109 is tilted by an angle θ₁ equal to 45°−θ/2, that is, equal, in this example, to approximately 37.0°.

The mechanical and optical assembly of adapter 100 on circuit 101 is obtained, for example, by means of transparent optical glue. The glue preferably has a refractive index close to that of transparent region 105, in order to limit parasitic reflections at the interfaces between the materials.

Further, adapter 100 is advantageously made of transparent materials having a refractive index close to that of the material of transparent region 105, for example silica glass. In the following description, it is considered, to simplify, that the refractive indices seen by light beam 108 are all equal to that of silica glass. However, in practice, materials having different refractive indices can be used, taking into account the refraction angles and losses due to parasitic reflections at the interfaces. Optical simulation software tools, such as the software known under trade name “Zemax,” may for example be used for this purpose.

According to an embodiment, optical adapter 100 comprises a transparent region 111, a converging mirror 113, for example a concave mirror, located on the side of a first surface 111B of transparent region 111 (the lower surface of region 111, in the orientation of FIG. 1) and a planar mirror 115 located on the side of a second surface 111T of transparent region 111 (the upper surface of region 111, in the orientation of FIG. 1) opposite surface 111B. Planar mirror 115 and converging mirror 113 are arranged so that beam 108 is reflected toward surface 111B by planar mirror 115 and then reflected and collimated by converging mirror 113 toward surface 111T. M₂ designates the point of intersection of the optical axis of beam 108 with planar mirror 115 on surface 111T, and M₂ the point of intersection of the optical axis with the surface of converging mirror 113. Between the output of the edge coupler and converging mirror 113, the beam widens along its path along a total length L equal to P₁M₁+M₁M₂+M₂M₃.

Converging mirror 113 enables to reflect and to collimate beam 108. It also enables to modify the inclination of the optical axis if it is manufactured so that the surface of converging mirror 113 forms, with respect to the horizontal, an angle θ₃ at point M₃. The converging mirror is then said to be inclined at an angle θ₃. In the shown example, it is desired to obtain a beam directed perpendicularly to surface 111T. An inclination given by θ₃=θ/2=8.0° is for example selected for this purpose.

After reflection on converging mirror 113, the collimated light beam comes out of adapter 100 through its upper surface. P₂ designates the point where the optical axis of the beam originating from the converging mirror intersects surface 111T of adapter 100.

In the external optical medium, located above adapter 100, P₃ designates the position of the center of the waist of Gaussian beam 108 and d₃ its diameter measured perpendicularly to the optical axis. In the shown example, the optical medium above adapter 100 is air. If incident beam M₃P₂ is not perpendicular to surface 111T, then the refracted beam directed along optical axis P₂P₃ exhibits a change in direction when crossing this surface. In the illustrated example, the inclination of converging mirror 113 is selected to direct the beam perpendicularly to the upper surface 111T of adapter 100, so that the optical axis remains perpendicular to this surface in the output medium above adapter 100. Further, referring to the concept of real and virtual images in optics, it can be said that point P₃ is a real image in the output medium if it is located above surface 111T, and that it is a virtual image in the output medium if it is located below surface 111T. In the example of embodiment shown in FIG. 1, point P₃ is a real image.

In the shown example, adapter 100 has a first optical port 117, or light port 117, located on the side of surface 111B, and a second optical port 119 located on the side of surface 111T. Optical port 117, called lower optical port or light port, is defined by the surface centered on point P₁ which propagates beam 108 with diameter d₁. Optical port 119, called upper optical port or light port, is defined by the surface centered on point P₃ which propagates beam 108 of diameter d₃. Adapter 100 ensures the propagation of light beam 108 between lower light port 117 and upper light port 119. The propagation can occur from lower port 117 to upper port 119 or from upper port 119 to lower port 117 with the same beam shape, according to the principle of reversibility of light. As an example, upper port 119 has a diameter d₃ at least five times greater than diameter d₁, for example equal to approximately 50 μm. This diameter is compatible with commercially available plug-in optical micro-connectors.

As an example, adapter 100 is manufactured on a silica glass wafer by implementing the following successive steps:
a) manufacturing of planar mirror 115 by photolithography, then etching of a metal layer, for example made of aluminum;
b) protection of planar mirror 115 with a silica layer;
c) flipping of the wafer and bonding to a temporary transfer substrate, or handle;
d) thinning and polishing of the wafer, then forming of the three-dimensional shapes defining converging mirror 113 and pickoff mirror 109;
e) metallization of the surfaces of mirrors 113 and 109, for example by deposition of an aluminum layer on the side of surface 111B, followed by photolithography operations and then etching of this layer; and
f) flipping of the wafer onto a soft adhesive support, removal of the temporary transfer substrate, and cutting of the wafer into chips, each forming an optical adapter 100.

The technique used to define the three-dimensional shapes of converging mirror 113 and of pickoff mirror 109 is, for example, grayscale photolithography in resist, followed, for example, by transfer etching in the silica glass. Alternatively, it is a lithography using a technique known as “nano-imprint lithography” using a three-dimensional mold. Alternatively, it is a direct laser writing followed by wet etching, a technique known as “selective laser etching.”

The assembly of adapter 100 on optical integrated circuit 101 is, for example, carried out by means of chip transfer equipment, for example of pick-and-place type, and of optically transparent glue. Optical glue which polymerizes under the action of ultraviolet radiation is used, for example, to mechanically secure the assembly after its installation. Preferably, glue capable of subsequently withstanding a temperature in the order of 250° C. for approximately 2 min. is used, so that the assembly formed of optical circuit 101 and of adapter 100 can withstand the passage through a solder reflow oven at 250° C. The materials forming adapter 100 are preferably selected to withstand the same stress.

An example of sizing is described hereafter in relation with FIG. 1. This example is however not limiting, and other sizings are available to those skilled in the art based on the indications of the present disclosure.

The calculations are disclosed for an operating wavelength λ₀=1.310 μm (wavelength measured in vacuum), but can be transposed to any other wavelength. One is placed in the situation in which the crossed materials all have the refractive index n of silica glass at this wavelength, that is, n=1.447.

It is considered that lower light port 117 is centered on point P₁ located at depth h₁ below the upper surface of optical integrated circuit 101, for example h₁=7.0 μm. It is considered that port 117 emits a circular Gaussian single-mode beam having a diameter d₁=9.0 μm. The Rayleigh length of this beam in a medium of index n is z_{R}=nπ(d₁/2)²/λ₀≃70.3 μm. The total beam divergence, assessed at 1/e² in intensity, is Δθ≃d₁/z_{R}≃128 mrad ≃7.3°.

An angle of inclination θ=16.0° is selected for the optical axis of light beam 108 relative to the vertical during its path between M₁, M₂, and M₃.

Pickoff mirror 109 is a planar mirror inclined at an angle θ₁=45°−θ/2=37.0°, so that the initially horizontal optical axis is reflected at an angle θ relative to the vertical. A distance x₁=10 μm between P₁ and M₁ is selected.

Adapter 100 is manufactured so that its upper surface 111T is at an altitude h₂=189.8 μm above the upper surface of optical integrated circuit 101. The planar mirror 115 which folds light beam 108 is located on surface 111T.

Converging mirror 113 is manufactured with an inclination θ₃=θ/2=8.0°, so that the optical axis of beam 108 is perpendicular to the upper surface of the adapter on path M₃P₂ after reflection. For point M₃, an altitude h₃=8.3 μm above the surface of optical integrated circuit 101 is selected. In this case, the length of the optical path between P₁ and M₃ is L=P₁M₁+M₁M₂+M₂M₃=x₁+(2h₂+h₁−h₃)/cos(θ)≃403.5 μm. The horizontal distance between M₁ and M₂ is x₂=(h₂+h₁) tan(θ)≃56.4 μm, and that between M₂ and M₃ x₃=(h₂−h₃) tan(θ)≃52.0 μm.

A spherical converging mirror 113 with a focal length f=394.0 μm is selected, which corresponds to a radius of curvature R=2 f≃788.0 μm. δs designates the distance along the optical axis between source point P₁ and the focal point of the converging mirror, δs=L−f=9.5 μm. The image of lower light port 117 formed by converging mirror 113 in the medium above adapter 100 has a waist with a diameter of: d₃=d₁ f(z_{R}²+δs²)^{-1/2}≃50.0 μm. This 50-μm beam diameter is compatible with optical plug-in micro-connectors available from connector manufacturers. The total divergence of the beam coming out in the air, assessed at 1/e² in intensity, is given by Δθ₃=4λ₀/(πd₃)≃33 mrad ≃1.9°. A wider beam is thus obtained, increasing from 9 to 50 μm in diameter, of lower divergence, decreasing from 7.3 to 1.9°.

For greater accuracy, account can be taken of the fact that the light beam strikes converging mirror 113 at an oblique angle of incidence θ/2 relative to the axis of mirror 113. Thus, as a variant, an ellipsoidal surface with radius R₁=2 f/cos(θ/2) in the plane of incidence (plane of FIG. 1) and R₂=2 f cos(θ/2) in the sagittal plane (perpendicular to the plane of incidence containing the optical axis) can be selected. Generally, those skilled in the art are capable of determining the ideal surface by using optical design software.

In the described situation, the waist of beam 108 seen in the silica after converging mirror 113 is located on the optical axis after the center M₃ of mirror 113 at a distance s′=1/(1/f−1/(L+z_{R}²/δs))≃689 μm. The altitude h₅ of the beam waist seen in the air above the upper surface of the adapter can be deduced as: h₅=(s′−h₂+h₃)/n+h₂≃540 μm. This value is the altitude of upper light port 119, centered on point P₃, above the upper surface 111T of adapter 100. In this case, if an optical micro-connector is assembled, the latter is positioned so that its light input coincides with the upper light port 119 of adapter 100.

Further, the bulk of the geometric shapes is designed to enable to assemble adapter 100 onto optical integrated circuit 101 without any collision between surfaces. For pickoff mirror 109, W₁ and H₁ respectively designate the width and the height of the portion of mirror 109 to the left of point M₁. One selects H₁=5.0 μm to leave a margin h′₁−H₁=2.0 μm between the bottom of pickoff mirror 109 and optical integrated circuit 101. It can be deduced that W₁=H₁/tan(θ₁)≃6.6 μm. For the portion of mirror 109 to the right of point M₁, there is no geometric constraint if cavity 107 is sufficiently wide, that is, if it is wider than x₁+h₁/tan(θ₁)≃16.6 μm. In this case, pickoff mirror 109 can be wider to the right of M₁ than to the left. For example, a cavity 107 wider than 20 μm is selected.

For converging mirror 113, W₃ and H₃ respectively designate the width and the height of the portion of mirror 113 to the left of point M₃. The diameter of the light beam 108 striking converging mirror 113 is given by: d₃₃=d₁(1+(L/z_{R})²)^{1/2}≃52.5 μm. To reflect most of the incident beam, one selects W₃=1.5 d₃/2=37.5 μm. It can be deduced that H₃=W₃ tan(θ₃)≃5.3 μm. The margin between the bottom of converging mirror 113 and the surface 111B of adapter 100 thus is h₃−H₃≃3.0 μm, which prevents a collision with surface 111B. The portion of converging mirror 113 to the right of point M₃ is higher, and there thus is no risk of collision with optical integrated circuit 101. By selecting a distance h₄=15.0 μm between the lower surface 111B of adapter 100 and the upper surface of optical integrated circuit 101, the width of mirror 113 to the right of point M₃ can be (h₄−h₃)/tan(θ₃)≃47.7 μm. Converging mirror 113 can thus be wider to the right of M₃ than to the left.

Since pickoff mirror 109 is truncated at the bottom, part of the light is lost because it is not reflected. The truncation occurs at a distance x₁₁=x₁−W₁≃3.4 μm from source point P₁, at which distance the diameter of light beam 108 is: d₁₁=d₁(1+(x₁₁/z_{R})²)^{1/2}≃9.0 μm. The truncation at distance H₁ below point M₁ thus causes an optical loss given by: lc₁=½(1+erf(−\sqrt{ }2(2H₁)/d₁₁))≃1.3%, where “erf” is the Gaussian error function.

Similarly, the light beam 108 striking converging mirror 113 is truncated on the left-hand side at a distance W₃ from point M₃, causing an optical loss lc₃≃½(1+erf(−\sqrt{ }2(2W₃/d₃₃))≃0.2% (the effect of the inclination θ₃ of converging mirror 113 is negligible in this calculation). Since the portion of converging mirror 113 located to the right of M₃ is larger than to the left, the loss of light to the right of converging mirror 113 is lower and is, in this case, negligible.

The folding of light beam 108 occurs by reflection on the planar mirror 115 located on the upper surface 111T of adapter 100. The optical axis intersects planar mirror 115 at point M₂ and the propagation distance between P₁ and M₂ is: L₂=x₁+(h₂+h₁)/cos(θ)≃215 μm. The diameter of beam 108 is then given by d₂=d₁(1+(L₂/z_{R})²)^{1/2}≃28.9 μm. Its length in the horizontal direction is d₂₂=d₂/cos(θ)≃30.1 μm. Planar mirror 115 can be extended to the left of M₂ with no immediate limitation. However, it cannot extend to the right of M₂ without limit because it would block part of the beam coming out of adapter 100 after reflection on converging mirror 113. A width W₂=20.5 μm is then selected for the edge of planar mirror 115 to the right of point M₂. In this situation, part of the light is not reflected by planar mirror 115, which results in a loss lc₂=1/2(1+erf (−\sqrt{ }2(2W₂)/d₂₂))≃0.3%. At the same time, part of the light coming out of upper surface 111T is blocked by planar mirror 115, resulting in a loss lc₄≃½(1+erf(−\sqrt{ }2(2(x₃−W₂)/d₃)≃0.6% (the diameter of beam 108 on upper surface 111T has been approximated by d₃, so as not to overload notations).

In total, the geometric losses mentioned are lc₁+lc₂+lc₃+lc₄≃2.4%, which is very low for most applications. Added to this are losses by reflection on the metal of the mirrors, which are in the order of 3.1% for a reflection on an aluminum surface. For three reflections, the cumulative loss is lₘ≃9.3%. The use of a metal that reflects light better, such as gold or silver, enables to decrease the value of these losses.

Further, the total footprint in the x direction to form the entire optical system is: x₁+x₂+x₃+d₃/2˜ 167 μm, which is compact.

The sensitivity of the optical system to variations in the geometry of adapter 100 and of its positioning on optical integrated circuit 101 is detailed hereafter in relation with FIG. 1. An adapter 100 which propagates light between optical integrated circuit 101 and an optical micro-connector (not shown in FIG. 1) is considered, and the tolerance allowing a transmission of more than 90% is determined for each error taken individually.

In the case of a shift of adapter 100 relative to optical integrated circuit 101, the lower optical port 117 connected to adapter 100 shifts with respect to the light port present in optical integrated circuit 101. Depending on the shifts in the three directions x, y, and z of space, the light transmission coefficient is T≃(1+δx²/(2z_{R})²)exp(−4(δy²+δz²)/d₁2). It has been assumed in this expression, that δx is much smaller than z_{R}, which is an easy condition to achieve in practice. It can be deduced that the positioning tolerances are δy (90%)=δz (90%)=1.5 μm and δx (90%)=47 μm. It can be observed that the positioning is more critical in the y and z directions. In the y direction, the right alignment may be aided by positioning elements such as fingers or tabs intended to fit into complementary cavities extending across the thickness of optical integrated circuit 101 from its upper surface. In the z direction, the right positioning may be ensured by bearings having a height selected so that the lower light port 117 of adapter 100 is at the same height as the light port of optical integrated circuit 101.

An error in angle θ₁ mainly results in an inclination of the lower optical port at an angle 2 δθ₁ relative to the vertical, so that the transmission coefficient is T≃exp(−4(2δθ₁/Δθ)²). It can be deduced that that δθ₁ (90%)=10.3 mrad=0.59°.

An error in angle θ₃ can be taken into account by considering the offset δz=2 L δθ₃ of the lower light port 117 relative to the optical integrated circuit. One has T≃exp(−4(2L δθ₃/d₁)²) and it can be deduced that δθ₃ (90%)=1.8 mrad=0.10°. Such accuracy in the manufacturing of deflection mirror 109 can be achieved, for example, by the grayscale photolithography technique, by the “nano-imprint lithography” technique, or by the “selective laser etching” technique.

An error in the thickness h₂ of the adapter results in a shift δz=2L δh₂ sin(θ) of lower light port 117 relative to optical integrated circuit 101. One has T≃exp(−4(2 δh₂ sin(θ)/d₁)²) and it can be deduced that δh₂ (90%)=2.6 μm. In practice, it is possible to thin and to polish a silica glass wafer while controlling the thickness with an accuracy better than this tolerance.

Optical integrated circuit 101 equipped with the adapter 100 according to the present invention can be used with a fiber optic connector designed to accept a widened light beam. It is, for example, a connector having microlenses at the ends of the optical fibers (available from Senko) or a ferrule which deflects light from the optical fibers by means of a curved turning mirror, acting both as an angle deflector and for beam collimation (available from USConec). Depending on the geometry of the considered optical connector, its orientation relative to adapter 100 and to optical integrated circuit 101 is adjusted so that the optical axes are aligned.

The present invention enables to use any type of optical connector. It is sufficient to dimension the thickness of adapter 100 and its converging mirror 113 to produce a widened beam with a diameter equal to the nominal mode diameter of the considered optical connector and positioned at the altitude required by this connector.

As a summary, adapter 100 has low optical losses and can be associated with various commercially available connectors, without being tied to a specific connector during design other than by the diameter and position of the beam waist expected by this connector. Further, the use of optical adapter 100 enables to simplify the design and the manufacturing of optical integrated circuit 101, since the optical functions related to the widening of the beam are gathered exclusively in adapter 100.

FIG. 2 is a detail view of the assembly of the optical connector 100 of FIG. 1 with optical integrated circuit 101.

In the shown example, cavity 107 is formed in optical integrated circuit 101 by etching the transparent region 105 of transparent layer 105 down to substrate 103, which is used as an etch stop layer. However, this example is not limiting, and the etching may, as a variant, be stopped before reaching substrate 103, in which case cavity 107 has a depth smaller than the thickness of transparent region 105. The transparent region 111 of optical adapter 100 comprises a portion 111S projecting from the lower surface 111B of region 111, portion 111S being intended to be inserted into cavity 107. Mirror 109 is located on projecting portion 111S. This enables to perform an edge coupling of a waveguide 201 formed in the transparent region 105 of circuit 101. In the shown example, waveguide 201 comprises a central region 201C, or core, surrounded by a peripheral region, or sheath, formed by transparent region 105. Central region 201C has a refractive index greater than that of peripheral region 105. Further, in this example, another waveguide 203 is located on top of and vertically in line with an end of waveguide 201 to enable to transfer light from waveguide 201 to an output port 205 of optical integrated circuit 101 located opposite the planar pickoff mirror 109 of optical adapter 100. Similarly to waveguide 201, waveguide 203 comprises a central region 203C, or core, surrounded by a peripheral region, or sheath, formed by transparent region 105. Waveguide 203 differs from waveguide 201, for example, in that it propagates a mode of larger diameter. As a variant, waveguide 203 may be omitted.

In the illustrated example, a transparent region 207, for example obtained by polymerization of a glue layer interposed between optical integrated circuit 101 and adapter 100, fills the free spaces extending between the upper surface of circuit 101 and the lower surface 100B of adapter 100.

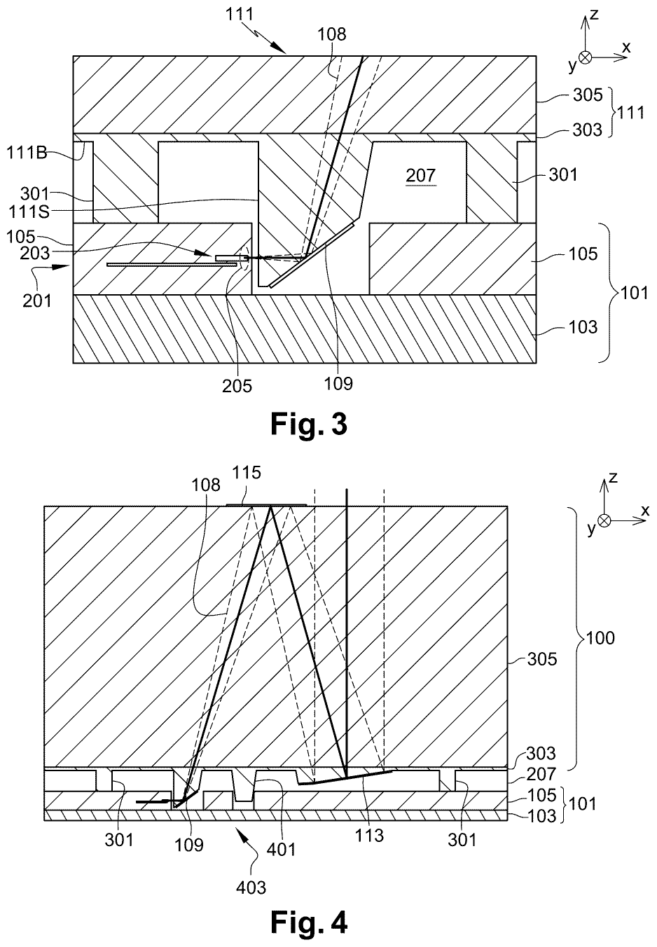

FIG. 3 is a side and cross-section view, simplified and partial, of a variant of the optical adapter 100 of FIG. 1.

In the shown example, transparent region 111 further comprises mechanical positioning elements 301, for example pads with no optical function, projecting from the lower surface 111B of region 111 and intended to bear on the upper surface of circuit 101. This enables to adjust the distance separating adapter 100 from circuit 101 along vertical axis “z”.

Further, in this example, transparent region 111 comprises a lower portion 303 facing the upper surface of circuit 101 and an upper portion 305 opposite to lower portion 303 and facing outward. For example, portion 305 is a silica glass plate and portion 303 is a polymer shaped by grayscale photolithography or by the “nano-imprint lithography” technique. As a variant, portions 303 and 305 are made of a same transparent material, for example silica glass, and the surfaces are formed, for example, by the “selective laser etching” technique.

In the shown example, optical integrated circuit 101 has optical output port 205 located on the end side of waveguide 203 opposite cavity 107.

FIG. 4 is a side and cross-section view, simplified and partial, of another variant of the optical adapter 100 of FIG. 1.

According to this variant, transparent region 111 comprises a portion 401 with no optical function, projecting from the lower surface 111B of adapter 100 and intended to be inserted into a cavity 403 of optical integrated circuit 101. Portion 401 has, for example, the shape of a tooth, of a finger, or of a tab, and acts as a mechanical positioning element for optical adapter 100 relative to optical integrated circuit 101. Portion 401 enables to facilitate and/or to improve the alignment of adapter 100 with respect to circuit 101, in particular the alignment along the horizontal axis “x” or alignment in the horizontal plane “xy.”

In the shown example, portion 401 with no optical function is formed in portion 303 of region 111.

Although only one portion 401 has been shown in FIG. 4, this example is not limiting, and adapter 100 may of course, as a variant, comprise more portions 401 with no optical function intended to be inserted into cavities previously formed in the upper surface of circuit 101.

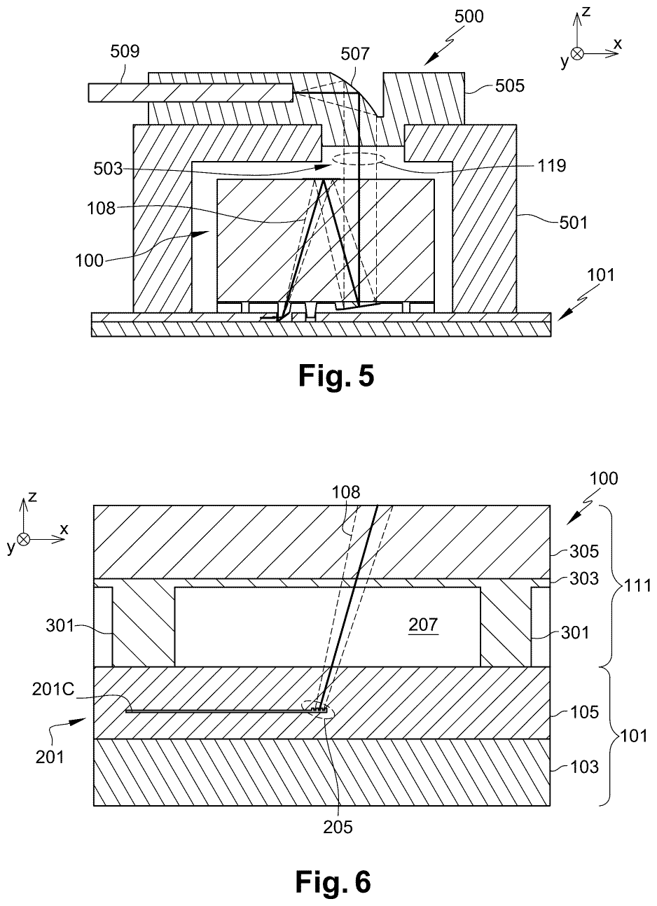

FIG. 5 is a side and cross-section view, simplified and partial, of an optical device 500 according to an embodiment.

In the shown example, optical device 500 comprises the assembly previously described in relation with FIG. 4, comprising optical integrated circuit 101 and optical adapter 100. Optical device 500 further comprises a support 501, or socket, or base, integral with the upper surface of optical integrated circuit 101 and surrounding optical adapter 100. Support 501 in particular has the function of allowing the mechanical placement of a micro-connector in the appropriate location above optical adapter 100. In this example, support 501 has an opening located opposite the upper light port 119 of optical adapter 100. Opening 503 enables to give way to the light beam 108 propagated by adapter 100.

In the shown example, optical device 500 further comprises an optical connector 505, for example a micro-optical connector, plugged into the opening 503 of support 501. In the shown example, optical connector 505 comprises a converging mirror 507, for example a concave mirror, enabling to reflect the light originating from optical adapter 100 toward an optical fiber 509, one end of which terminates in optical connector 505. In this example, the optical conjugate of optical port 119 via converging mirror 507 is located on the end of optical fiber 509.

An advantage of optical device 500 lies in the fact that the use of a light beam 108 widened at the level of optical port 119 enables to increase the positioning tolerance for optical connector 505, so that it is possible to use an optical connector pluggable into socket 501 positioned on optical integrated circuit 101. The assembly of optical adapter 100 to optical integrated circuit 101 enables to obtain said widened light beam.

FIG. 6 is a side and cross-section view, simplified and partial, of a variant of optical integrated circuit 101.

In the shown example, the optical coupling between the waveguide 201 of optical integrated circuit 101 and optical adapter 100 is achieved by a diffraction grating located at the end of guide 201 and formed, for example, by partial etching of a periodic structure into the core 201C of the guide. This diffraction grating forms an optical port 205 for receiving or emitting a light beam 108.

In this case, optical integrated circuit 101 does not comprise cavity 107 and optical adapter 100 does not comprise the portion 111S of transparent region 111 projecting from surface 111B and from planar turning mirror 109. As an example, optical adapter 100 comprises no optical function other than that implemented by planar mirror 115, converging mirror 113, and transparent region 111.

Various embodiments and variants have been described. Those skilled in the art will understand that certain features of these various embodiments and variants may be combined, and other variants will occur to those skilled in the art. In particular, the adaptation of optical device 500 to the case of a coupling by a diffraction grating as previously described in relation with FIG. 6 is within the abilities of those skilled in the art based on the indications of the present disclosure.

Finally, the practical implementation of the described embodiments and variants is within the abilities of those skilled in the art based on the functional indications given hereabove. In particular, the described embodiments are not limited to the specific examples of materials and of dimensions mentioned in the present disclosure.

1. Optical adapter comprising:
a transparent region;
a converging mirror located on the side of a first surface of the transparent region and facing a second surface of the transparent region, opposite to the first surface;
a first planar mirror located on the side of the second surface of the transparent region and facing the first surface;
a first optical port located on the side of the first surface and intended to be positioned opposite one end of a waveguide of an optical integrated circuit;
a second optical port located on the side of the second surface; and
a second planar mirror located on a portion of the transparent region projecting from its first surface, said portion being intended to be inserted into a cavity of the optical integrated circuit,
the optical adapter being intended to ensure a propagation of a light beam between said end of the waveguide and the second optical port, the first planar mirror and the converging mirror being arranged so that the light beam propagates between the first and second optical ports, through the transparent region, by reflection on the first planar mirror and on the converging mirror, the light beam having, at the second optical port, a size greater than the one that it has at the first optical port.

2. Adapter according to claim 1, wherein the transparent region further comprises at least one element for mechanically positioning the adapter with respect to the optical integrated circuit.

3. Adapter according to claim 2, wherein said at least one mechanical positioning element projects from the first surface of the transparent region.

4. Adapter according to claim 2, wherein said at least one mechanical positioning element comprises at least one pad having no optical function intended to bear against the optical integrated circuit.

5. Adapter according to claim 2, wherein said at least one mechanical positioning element further comprises at least one finger having no optical function and intended to be inserted into a cavity of the optical integrated circuit.

6. Adapter according to claim 1, wherein the first and second optical ports are respectively adapted to receiving and emitting the light beam.

7. Adapter according to claim 1, wherein the first surface of the transparent region is parallel to its second surface, the first planar mirror being parallel to the second surface.

8. Adapter according to claim 1, wherein the second optical port is intended to be positioned opposite an optical connector having one end of an optical fiber ending into it.

9. Optical device comprising an optical integrated circuit and the optical adapter according to claim 1, the optical adapter being mechanically integral with the optical integrated circuit.

10. Device according to claim 9, wherein the optical adapter is attached to the optical integrated circuit by a layer of optically transparent glue.

11. Device according to claim 9, further comprising at least one optical connector positioned opposite the second optical port and having the end of an optical fiber ending into it.
